(19) United States
(12) Patent Application Publication
(10) Pub. No.: US 2026/0277548 A1
(43) Pub. Date: Sep. 17, 2026

(54) DATAFLOW ARCHITECTURE FOR HIGH-PERFORMANCE ASICS

(71) Applicant: XgenSilicon Inc., Santa Clara, CA (US)

(72) Inventors: Bin Xu, Cupertino, CA (US); Ravindra Ganti, Mountain House, CA (US)

(21) Appl. No.: 19/564,005

(22) Filed: Mar. 11, 2026

Related U.S. Application Data
(60) Provisional application No. 63/772,408, filed on Mar. 14, 2025.

(51) Int. Cl. G06F 7/575; G06F 13/28

(52) U.S. Cl. CPC G06F 7/575; G06F 13/28

(57) ABSTRACT

The present disclosure relates to an integrated circuit system for dataflow management. The system includes multiple compute cores and an interconnect structure that couples the compute cores together. Each compute core can include one or more register files configured to store operand data, an algorithm-logic unit (ALU) coupled to the register files to perform operations based on the operand data, and an input/output unit (IOU) coupled to the register files and the ALU. The interconnect structure can include multiple addressable pipeline registers disposed between different compute cores. At least one addressable pipeline register can be coupled to one or more register files in a compute core through the IOU of the respective compute core. In this system, data from the addressable pipeline register can be provided directly to the register files of that compute core as operand data without relying on a typical memory as the transfer medium.

### CROSS-REFERENCE TO RELATED APPLICATIONS

This application claims the benefit of and priority to U.S. Provisional Patent Application No. 63/772,408, filed on Mar. 14, 2025, and entitled “DATAFLOW ARCHITECTURE FOR HIGH-PERFORMANCE ASICS,” the entire disclosure of which is hereby incorporated by reference.

### TECHNICAL FIELD

The present disclosure relates to dataflow management in integrated circuit systems. More particularly, the disclosure relates to systems and methods for managing data among multiple compute cores within an integrated circuit, including application-specific integrated circuits (ASICs), to support parallel computation.

### BACKGROUND

An application-specific integrated circuit (ASIC) is usually a semiconductor chip designed for a particular application or a class of applications. Compared with general-purpose processors, ASICs are typically designed to optimize performance, power efficiency, and/or area efficiency for a targeted workload.

In some control-flow architectures, such as von Neumann architectures, program execution follows a predefined instruction order. Instructions are issued and executed based on program control flow, while data is retrieved from memory through load and store operations. The achievable parallelism is often influenced by instruction scheduling, data movement, and memory-access behavior.

A dataflow architecture, on the other hand, is a type of computer architecture in which the execution of operations is triggered by the availability of input data rather than by a predetermined program order. In a dataflow system, computational units consume data tokens as inputs and produce output tokens, and dependencies between operations are represented by data availability. Dataflow architectures have been applied in various application-specific systems, including signal processing, imaging, and communication workloads, where computation can be naturally expressed as data-dependent operations.

For workloads requiring large-scale parallel computation, such as machine learning and deep neural network processing, some high-performance systems continue to adopt control-flow-based architectures. These systems typically rely on hierarchical memory organizations or non-uniform memory access (NUMA) mechanisms to supply data to multiple compute cores. Representative examples include graphics processing units (GPUs), tensor processing units (TPUs), and neural processing units (NPUs).

### SUMMARY

High-performance integrated circuits, including application-specific integrated circuits (ASICs), can support parallel execution across many compute cores. In such systems, both data handling and compute capability can limit overall throughput.

Typical parallel systems are memory-centric and use memory to supply data to compute cores. Data transfers between cores are often carried out by memory operations and/or by direct memory access (DMA) over an interconnect structure. In some systems, a compute core also includes a per-core local memory (LMEM) that is used as a staging buffer for incoming or outgoing inter-core data. For example, tensor data received from another core may be written into LMEM first and later moved from LMEM into in-core register files for instruction execution.

In some high-performance parallel systems, a compute core sends data to another core by first writing the data to memory, and the other core later reads the same data back from memory. This adds extra memory traffic in addition to the computation. The added write and read operations can increase latency and energy use, especially when the same intermediate results are produced and consumed repeatedly. Also, when data is exchanged through memory, the software often sees the data mainly as addresses in a shared address space. As a result, the compiler may not know where the source (producer) core and destination (consumer) core are located on chip, or how far the data will travel through the interconnect structure and memory system. This can make it harder to plan data placement, schedule transfers, and coordinate source/destination execution across many cores.

To address the above deficiency, the present disclosure provides a dataflow-based ASIC architecture. In the disclosed architecture, data generated by a source core can be transferred to a destination core without first being written to and later read from a typical memory structure. Instead, data is carried through addressable pipeline registers that are coupled to an interconnect structure. These pipeline registers provide identifiable transfer points for data as it moves from the source core to the destination core, and allow the data to be delivered directly to where it will be operated on. In this way, data transfer and computation can be more closely aligned at the architectural level.

For example, the present disclosure provides an integrated circuit system for dataflow management. The system includes multiple compute cores and an interconnect structure that couples the compute cores together. Each compute core can include one or more register files configured to store operand data, an algorithm-logic unit (ALU) coupled to the register files to perform operations based on the operand data, and an input/output unit (IOU) coupled to the register files and the ALU. The interconnect structure can include multiple addressable pipeline registers disposed between different compute cores. At least one addressable pipeline register can be coupled to one or more register files in a compute core through the IOU of the respective compute core. In this system, data from the addressable pipeline register can be provided directly to the register files of that compute core as operand data without relying on a typical memory as the transfer medium.

The disclosed architecture can reduce data-movement latency by allowing data to be transferred from a source core to a destination core without intermediate write and read operations through a typical memory structure. By reducing reliance on repeated memory accesses for data exchange between compute cores, the architecture can also reduce power consumption associated with memory traffic.

Providing operand data to register files directly from addressable pipeline registers can support higher effective data access bandwidth for computation, since data can be delivered to a destination core without additional memory indirection. Coordinating data transfer with instruction execution can reduce the need for temporary buffering between a source core and a destination core and can help align data arrival with computation in parallel workloads.

In addition, transferring data via addressable pipeline registers on the interconnect structure can make data movement paths between compute cores easier to coordinate at the architectural level. As a result, the disclosed architecture can support improved performance and energy efficiency when scaling to high-performance ASIC systems, such as those used for machine learning and deep neural network applications.

### BRIEF DESCRIPTION OF THE DRAWINGS

The present application can be best understood by reference to the embodiments described below taken in conjunction with the accompanying drawing figures, in which like parts may be referred to by like numerals.

FIG. 1 illustrates an example mapping of tensors to corresponding memory addresses, in accordance with examples disclosed herein.

FIG. 2 illustrates an example arrangement of compute cores and a router including multiple addressable pipeline registers (APRs), in accordance with examples disclosed herein.

FIG. 3 illustrates an example of a compute core architecture, in accordance with examples disclosed herein.

FIG. 4 illustrates an example format of capsule code, including an I/O portion and an instruction portion for execution, in accordance with examples disclosed herein.

FIG. 5 illustrates an example of directory and memory management unit (MMU) page table, in accordance with examples disclosed herein.

FIG. 6 illustrates an example format of control flits and data flits used for data transfer over an interconnect structure, in accordance with examples disclosed herein.

FIG. 7 illustrates a flowchart of an example dataflow management, in accordance with examples disclosed herein.

### DETAILED DESCRIPTION

To provide a more thorough understanding of various embodiments of the present invention, the following description sets forth numerous specific details, such as specific configurations, parameters, examples, and the like. It should be recognized, however, that such description is not intended as a limitation on the scope of the present invention but is intended to provide a better description of the exemplary embodiments.

Throughout the specification and claims, the following terms take the meanings explicitly associated herein, unless the context clearly dictates otherwise:

The phrase “in one embodiment” as used herein does not necessarily refer to the same embodiment, though it may. Thus, as described below, various embodiments of the disclosure may be readily combined, without departing from the scope or spirit of the invention.

As used herein, the term “or” is an inclusive “or” operator and is equivalent to the term “and/or,” unless the context clearly dictates otherwise.

The term “based on” is not exclusive and allows for being based on additional factors not described unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of a networked environment where two or more components or devices are able to exchange data, the terms “coupled to” and “coupled with” are also used to mean “communicatively coupled with”, possibly via one or more intermediary devices. The components or devices can be optical, mechanical, and/or electrical devices.

Although the following description uses terms “first,” “second,” etc. to describe various elements, these elements should not be limited by the terms. These terms are only used to distinguish one element from another. For example, a first APR could be termed a second APR and, similarly, a second APR could be termed a first APR, without departing from the scope of the various described examples. The first APR and the second APR can both be APRs and, in some cases, can be separate and different APRs.

In addition, throughout the specification, the meaning of “a”, “an”, and “the” includes plural references, and the meaning of “in” includes “in” and “on”.

Although some of the various embodiments presented herein constitute a single combination of inventive elements, it should be appreciated that the inventive subject matter is considered to include all possible combinations of the disclosed elements. As such, if one embodiment comprises elements A, B, and C, and another embodiment comprises elements B and D, then the inventive subject matter is also considered to include other remaining combinations of A, B, C, or D, even if not explicitly discussed herein. Further, the transitional term “comprising” means to have as parts or members, or to be those parts or members. As used herein, the transitional term “comprising” is inclusive or open-ended and does not exclude additional, unrecited elements or method steps.

As used in the description herein and throughout the claims that follow, when a system, engine, server, device, module, or other computing element is described as being configured to perform or execute functions on data in a memory, the meaning of “configured to” or “programmed to” is defined as one or more processors or cores of the computing element being programmed by a set of software instructions stored in the memory of the computing element to execute the set of functions on target data or data objects stored in the memory.

It should be noted that any language directed to a computer should be read to include any suitable combination of computing devices or network platforms, including servers, interfaces, systems, databases, agents, peers, engines, controllers, modules, or other types of computing devices operating individually or collectively. One should appreciate the computing devices comprise a processor configured to execute software instructions stored on a tangible, non-transitory computer readable storage medium (e.g., hard drive, FPGA, PLA, solid state drive, RAM, flash, ROM, or any other volatile or non-volatile storage devices). The software instructions configure or program the computing device to provide the roles, responsibilities, or other functionality as discussed below with respect to the disclosed apparatus. Further, the disclosed technologies can be embodied as a computer program product that includes a non-transitory computer readable medium storing the software instructions that causes a processor to execute the disclosed steps associated with implementations of computer-based algorithms, processes, methods, or other instructions. In some embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges among devices can be conducted over a packet-switched network, the Internet, LAN, WAN, VPN, or other type of packet switched network; a circuit switched network; cell switched network; or other type of network.

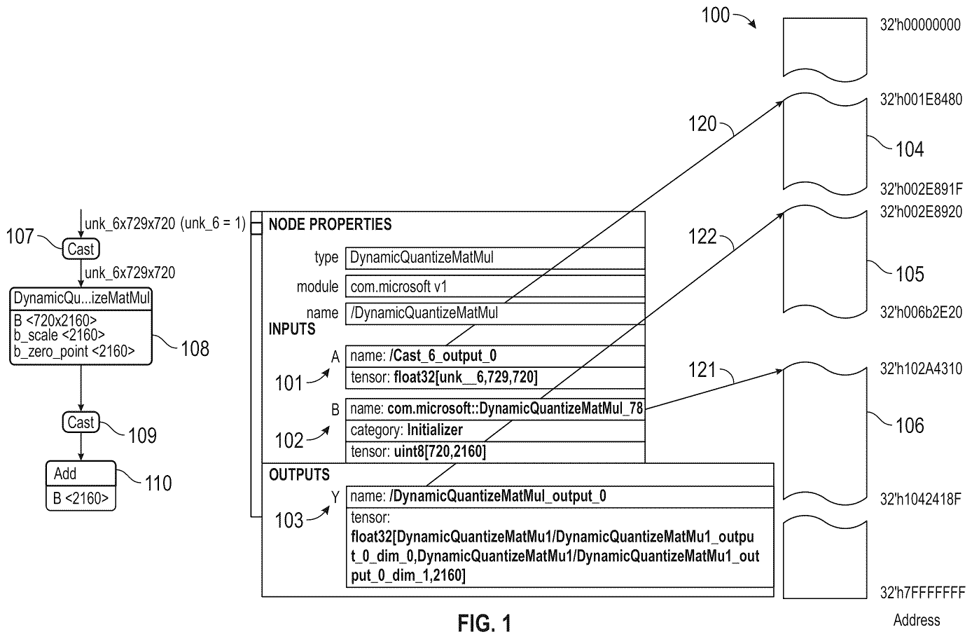

FIG. 1 illustrates an example of application compilation using a workload that can be represented as an operator graph. The left side of FIG. 1 shows an example operator chain (operators 107-110) in which the output of one operator is provided as an input to a downstream operator. The center portion of FIG. 1 shows a node description for one operator in that chain, where the node corresponds to an operator instance and lists its properties, its input tensors (for example, tensors 101 and 102), and its output tensor (for example, tensor 103). The right side of FIG. 1 shows an example memory space 100. Memory space 100 is an example logical memory space (or address space) used by the compiled application. In this example, a compiler assigns one or more addresses to each tensor, and arrows 120, 121, and 122 in FIG. 1 indicate that the tensor data associated with particular tensors are stored at corresponding locations in the address space. Address 104, address 105, and address 106 are example addresses (or address ranges) in memory space 100. The address values shown next to the address ranges are illustrated in a hexadecimal-style notation (e.g., values prefixed with 32′h), and are shown only as examples of where tensor data can reside in in memory space 100 associated with the address space.

A tensor, as used in FIG. 1, is a named data object that has a tensor specification. The tensor specification describes the data type and shape of the tensor. The central box in FIG. 1 shows a node description that includes node properties, input tensors, and output tensors for an operator node. In the node properties, “type: DynamicQuantizeMatMul” means the illustrated node is a matrix-multiplication operator labeled “DynamicQuantizeMatMul.” “module: com.microsoft v1” means the node is associated with a module or domain labeled “com.microsoft” and a version labeled “v1.” The node also includes a name field, shown as “name: /DynamicQuantizeMatMul,” which is an example identifier for the operator instance.

With reference still to FIG. 1, the inputs section shows two input tensors labeled A and B. Input tensor 101 corresponds to A. Input tensor 101 includes a name field and a tensor field. “name: /Cast_6_output_0” means the tensor value provided as input A is identified by the string “/Cast_6_output_0,” and the naming indicates that input A can be the output of an earlier cast operator in the operator sequence. “tensor: float32[unk_6, 729, 720]” means input A has element type “float32” and a three-dimensional shape “[unk_6, 729, 720].” “float32” means each tensor element is a 32-bit floating-point value. “unk_6” means the first dimension is represented as an unknown or symbolic dimension at compile time. The left-side operator chain also shows “unk_6=1,” which provides an example value for that unknown dimension in the illustrated case. “729” and “720” mean the second and third dimensions are 729 and 720, respectively.

Input tensor 102 corresponds to B. Input tensor 102 includes a name field, a category field, and a tensor field. “name: com.microsoft::DynamicQuantizeMatMul_78” means input B is identified by the string “com.microsoft::DynamicQuantizeMatMul_78.” “category: initializer” means input B is an initializer tensor, which indicates that input B can be treated as a parameter or constant tensor supplied to the operator rather than being produced as an intermediate result by a preceding operator. “tensor: uint 8[720, 2160]” means input B has element type “uint8” and a two-dimensional shape “[720, 2160].” “uint8” means each element is an 8-bit unsigned integer. “729×2160” means the tensor can be viewed as a matrix having 720 rows and 2160 columns.

In FIG. 1, the outputs section of the node shows an output tensor Y. Output tensor 103 corresponds to Y. Output tensor 103 includes a name field and a tensor field. “name: /DynamicQuantizeMatMul_output_0” means the output tensor is identified by the string “/DynamicQuantizeMatMul_output_0.” The tensor field indicates the output is a “float32” tensor, the same as input tensor 101. Similar to input tensor 101, output tensor 103 also has a three-dimensional shape and one of the dimensions is 2160.

The operator sequence on the left side of FIG. 1 includes cast operator 107, operator 108 labeled “DynamicQuantizeMatMul,” cast operator 109, and add operator 110. Cast 107 means an operator that converts tensor data from one data type to another data type. The label “unk_6×729×720” shown near cast 107 indicates a tensor shape having dimensions “unk_6,” “729,” and “720,” and the note “unk_6=1” indicates an example value for the unknown dimension in this illustration. Operator 108 labeled “DynamicQuantizeMatMul” indicates the matrix-multiplication operator corresponding to the central node properties. The labels shown next to operator 108 include “B<720×2160>,” “b_scale<2160>,” and “b_zero_point<2160>.” “B<720×2160>” means the initializer tensor B has a shape of 720 by 2160. “b_scale<2160>” means a scale array is shown with length 2160. “b_zero_point<2160>” means a zero-point array is shown with length 2160. Cast 109 means another cast operator positioned after the matrix multiplication operator, indicating that an output tensor from operator 108 can be converted to another type before being used by a downstream operator. Add operator 110 means an operator that performs an addition between operands, and the label “B<2160>” shown near add operator 110 indicates that an operand associated with the add operation has a dimension size of 2160 in the illustrated context.

In FIG. 1, the mapping aspect is illustrated by arrows 120, 121, and 122 that connect the tensor entries in the node description to address ranges in memory space 100. In one example, arrow 120 connects tensor 101 to address 104. This illustrates that, during compilation, storage for the data of tensor 101 (or a portion of tensor 101) is assigned to the address range indicated by address 104 (e.g., 32′h001E8480-32′h002E891F), so that the operator can refer to tensor 101 by the assigned address when the operator is executed. In another example, arrow 121 connects tensor 102 to address 105. This illustrates that during compilation, storage for the data of tensor 102 is assigned to the address range indicated by address 105 (e.g., 32′h002E8920-32′h006b2E20), such that the operator can obtain the parameter data for tensor 102 from that assigned location. In a further example, arrow 122 connects tensor 103 to address 106. This illustrates that, during compilation, storage for the output tensor 103 (or a portion of the output tensor 103) is assigned to the address range indicated by address 106 (e.g., 32′h102A4310-32′h1042418F), so that the output of the operator can be stored at the assigned location and later referenced by address by downstream operators. In this way, FIG. 1 illustrates that tensors identified in the operator graph are assigned locations in an address space during compilation, and execution can reference tensor data using the assigned addresses.

In some examples, application compilation includes generating capsule code for execution on the plurality of compute cores. For example, a compiler can compile an application workload into capsule code, where the capsule code carries tensor identifiers and instruction information. In some examples, the compiler also produces a compute application binary interface (ABI) and a network-on-chip (NoC) ABI. The compute ABI can provide information used by a compute core for execution of one or more operations on tensor data, for example including instruction and register usage information corresponding to capsule code execution. The NoC ABI can provide information used for routing and data transfer on the interconnect structure, for example including mapping information that populates or configures directory entries such that tensor identifiers are associated with nodes and addressable locations on the interconnect structure according to the directory. In this way, compilation can produce (i) capsule code for coordinating data transfer and computation, (ii) a compute ABI for execution on the compute cores, and (iii) a NoC ABI for routing on the interconnect structure according to the directory.

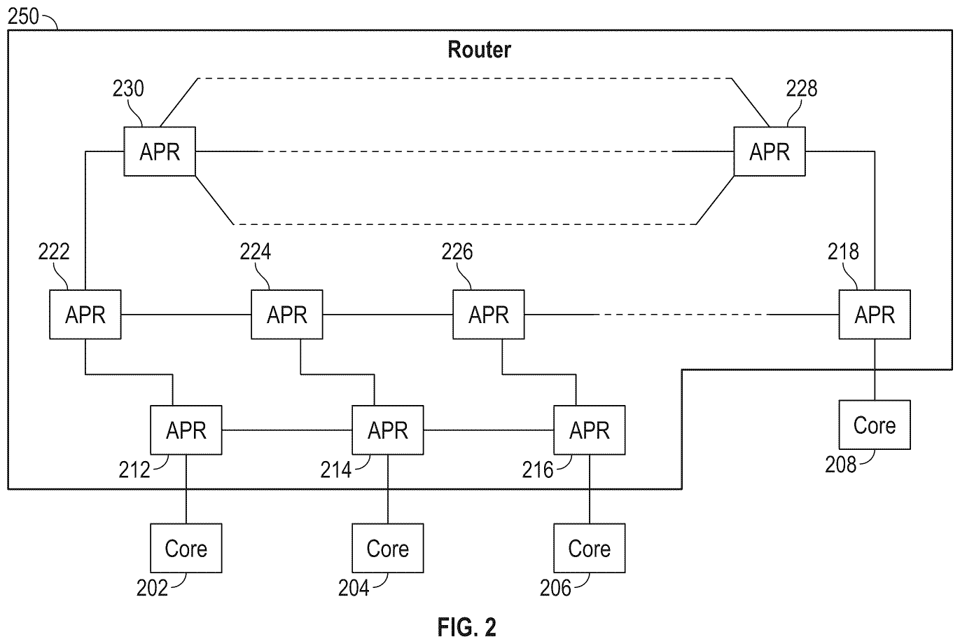

FIG. 2 illustrates an example interconnect structure 250 that couples multiple compute cores (e.g., compute cores 202, 204, 206, and 208) and multiple addressable pipeline registers (APRs) (e.g., APRs 212-230). Interconnect structure 250 can be implemented as, or can include, a router and interconnect links that allow data to move between different parts of the structure. In this figure, APRs are disposed along paths of interconnect structure 250 so that data can be staged at one or more intermediate locations while traveling from a source core to a destination core.

An APR (e.g., any of APRs 212-230) can be a storage element that temporarily holds tensor data, or a portion of tensor data, during transfer. An APR is “addressable” in the sense that the APR, or one or more locations within the APR, can be referenced using an identifier or address-related control information, such as control information used by an IO unit and/or a DMA mechanism associated with a compute core. In this way, a compute core can direct a data transfer, like read data from a particular APR location and/or write data to a particular APR location, rather than treating the inter-core transfer as a write to memory followed by a read from memory.

FIG. 2 also illustrates that APRs can be connected in different topologies within interconnect structure 250, and the connections can be understood using the numbered APRs as examples. In the illustrated example, some APR pairs are directly connected by a link, such as APR 212 and APR 214, APR 214 and APR 216, and APR 212 and APR 222, where a direct connection allows data to move from one APR to the other without passing through another APR. In some examples, data flits are transferred directly between adjacent APRs that are directly connected by a link (e.g., between APR 214 and APR 212). In FIG. 2, some APRs are connected indirectly through one or more intermediate APRs. For example, APR 212 and APR 216 can communicate through APR 214, and APR 212 and APR 224 can communicate through APR 222 and/or APR 214 depending on the selected path. FIG. 2 also illustrates a layered view of the APR placement. For example, APR 212, APR 214, and APR 216 can be viewed as a first layer near the lower portion of the router, while APR 222, APR 224, APR 226, and APR 218 can be viewed as another layer above them, and additional APRs such as APR 228 and APR 230 can be positioned along longer paths near an upper portion of the structure. This layered description is only one way to describe the placement and does not require that only APRs in a particular layer connect to compute cores. In some examples, APRs in multiple layers can be directly connected to compute cores. In other examples, only APRs in one layer are directly connected to compute cores while APRs in other layers serve as intermediate staging points and are not directly connected to compute cores. In all of these cases, the APRs remain addressable so that transfers can target specific APR locations even when the data traverse different numbers of hops.

In some examples, one or more APRs are directly coupled to a compute core. For example, as shown in FIG. 2, APR 212 is directly coupled to compute core 202, APR 214 is directly coupled to compute core 204, APR 216 is directly coupled to compute core 206, and APR 218 is directly coupled to compute core 208. In some examples, one or more APRs can serve as intermediate staging points and are not directly connected to a compute core. For example, APRs such as 222, 224, 226, 228, and/or 230 can be used as intermediate stops along a path. In these examples, addressability allows a transfer to target specific APR locations even when an APR is not directly attached to a compute core.

Example transfers can be illustrated by FIG. 2 using compute core 202 as an example destination core. In one example, if destination core 202 needs a data item and that data item is located in APR 214, destination core 202 (or a control mechanism acting for destination core 202) can cause the data item to be transferred from APR 214 to APR 212 and then delivered into compute core 202. This example illustrates a direct APR-to-APR hop between APR 214 and APR 212, where the data can move to the destination APR (e.g., APR 212) coupled to destination core 202 from the source APR (e.g., APR 214) without passing through another intermediate APR.

In another example, if destination core 202 needs a data item that is located in APR 216, the transfer to destination core 202 can traverse one or more intermediate APRs before reaching APR 212. For example, the data item can be transferred from APR 216 to APR 214, then from APR 214 to APR 212, and then delivered into compute core 202. This example shows a multi-hop path in which an intermediate APR (e.g., APR 214) is used as a staging point between the source APR (e.g., APR 216) holding the data and the destination APR (APR 212) directly coupled to destination core 202.

In a further example, if destination core 202 needs a data item that is located in APR 218, the transfer can traverse a longer path across interconnect structure 250 and across different portions or layers of the APR topology. For example, the data item can be transferred from APR 218 to APR 228, then from APR 228 to APR 230, then from APR 230 to APR 222, then from APR 222 to APR 212, and then delivered into compute core 202. This example illustrates that, even when the data originates at the source APR (e.g., APR 218) that is farther away and not in the same local portion of the structure as destination core 202, the data can be moved through a sequence of addressable APR staging points until the data reaches the destination APR (e.g., APR 212) coupled to destination core (e.g., core 202).

FIG. 2 also supports examples in which a larger data object or a tensor is partitioned into multiple portions (e.g., subtensors or data flits) and different portions follow different paths through interconnect structure 250. For example, a first portion of the data in source APR 218 can travel along a path such as APR 218→APR 228→APR 230→APR 222 →APR 212→destination core 202, while a second portion of the data in source APR 218 can travel along a path such as APR 218→APR 226→APR 224→APR 214→APR 212→destination core 202. In these examples, the portions can be transferred in parallel or in an interleaved manner, and the destination core 202 can begin operating on portions as portions arrive, depending on the instruction and operand usage.

After destination core 202 performs a computation using the received data, FIG. 2 also supports examples of output staging. In some examples, destination core 202 can place a resulting tensor (or a portion of a resulting tensor) into APR 212 (now serves as an output APR) so that the result is available for retrieval by another compute core through interconnect structure 250. In some examples, the output APR is the same APR as the destination APR coupled to the destination compute core. In some examples, destination core 202 produces multiple results, and some of the result portion can be staged into APR 212 for use by another core while some other result portion is retained within destination core 202 (e.g., retained in a local register file or other local storage) for use by a subsequent computation executed by destination core 202. In this way, FIG. 2 illustrates that APRs can be used both for inbound staging of operands to a destination core and for outbound staging of results from a destination core, with flexibility in whether data is staged into an APR or retained locally depending on the use of the data.

FIG. 2 shows one example in which each compute core is drawn as directly coupled to one APR (e.g., compute core 202 to APR 212 and compute core 204 to APR 214). This arrangement is only an example. In other examples, a compute core can be directly coupled to multiple APRs, and different directly coupled APRs can be used for different data items or different stages of execution. For example, destination core 202 can receive an input operand through one directly coupled APR (such as APR 212) and, after performing a computation, place at least part of an output through another directly coupled APR (not shown) associated with destination core 202. In other examples, an APR that is directly coupled to a compute core can also be directly coupled to multiple compute cores, so that the APR can serve as a shared staging point that multiple cores can read from and/or write to, depending on the transfer control. In still other examples, when a compute core produces a result, the compute core can store different portions of the result into different directly coupled APRs (e.g., output APRs) rather than storing all result data into a single output APR, for example to support different destination cores retrieving different portions or to support overlapping transfers. In some cases, the same compute core can act as a destination core for one transfer and act as a source core for another transfer, depending on whether the compute core is receiving operand data or staging result data.

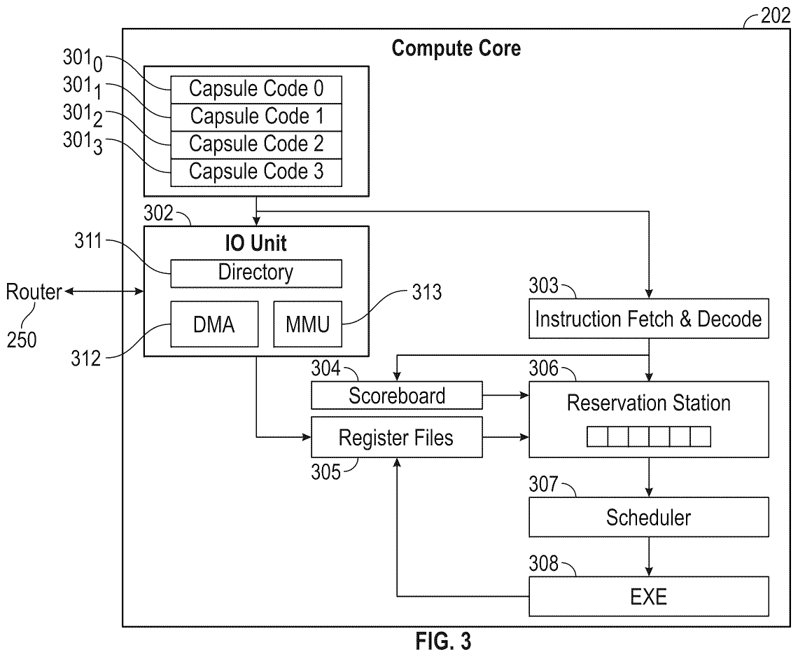

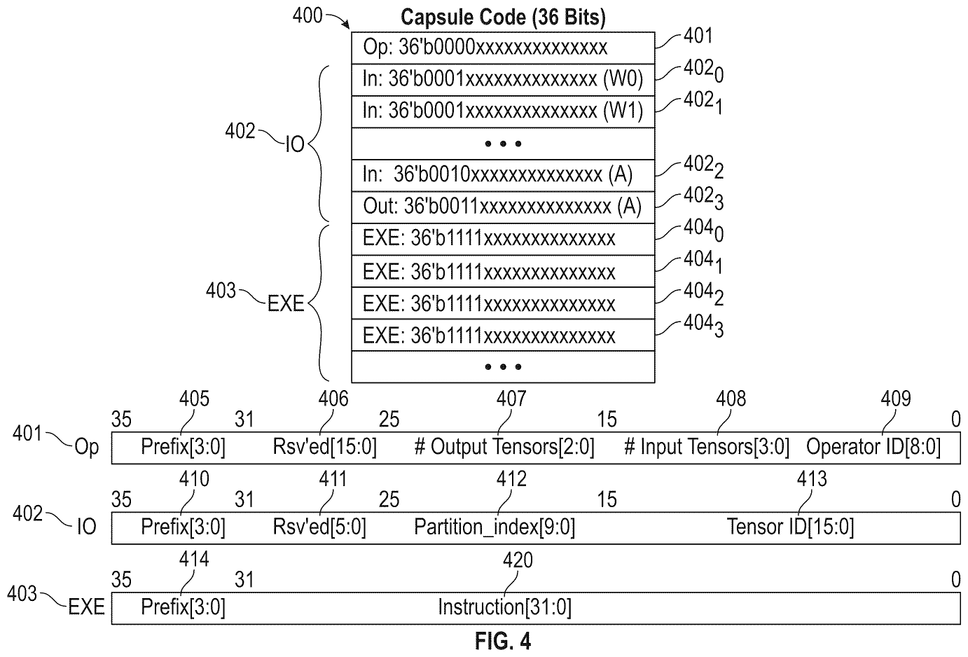

With reference to FIGS. 2 and 3, an example compute core architecture 202 is illustrated, in which instruction execution within the compute core is coordinated with tensor data transfer through an input/output path coupled to router 250. In some examples, compute core 202, as well as compute cores 204, 206, and 208 of FIG. 2, can each be implemented as a tensor compute core configured to perform operations on tensor data. In the illustrated example, compute core 202 receives capsule codes 301₀-301₃. A capsule code can include (i) tensor-related information used to identify one or more tensors to be obtained or produced for an operation, and (ii) one or more instructions associated with that operation. The details of capsule code (e.g., capsule codes 301₀-301₃) is described further in FIG. 4. Compute core 202 includes an IO Unit (IOU) 302 coupled to router 250, and includes an execution pipeline that includes instruction fetch and decode logic 303, scoreboard 304, register files 305, reservation station 306, scheduler 307, and execution logic 308. In this arrangement, the IOU 302 can coordinate data transfers through router 250 while the execution pipeline issues and executes instructions when corresponding operand data becomes available in register files 305.

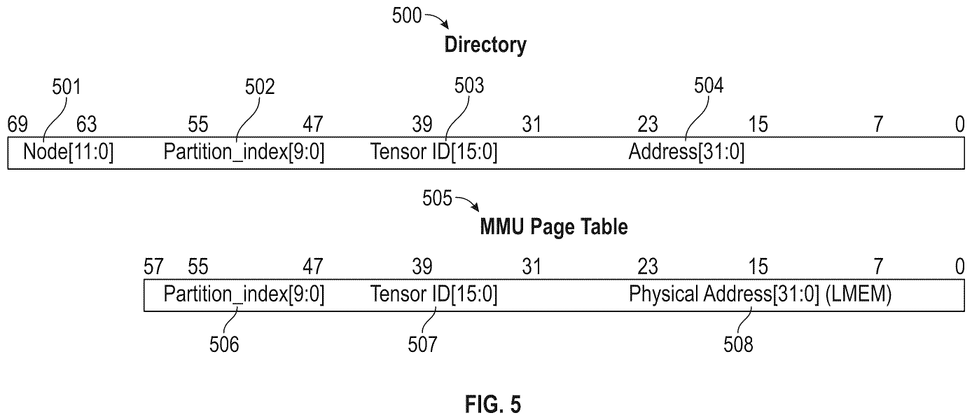

Router 250 represents an interconnect interface that can deliver data and control information between compute core 202 and other parts of an ASIC, including APR-based staging along the interconnect as described in FIG. 2. In some examples, multiple compute cores and the interconnect structure are included in a semiconductor chip, such as an ASIC chip. IOU 302 provides an interface between router 250 and the internal pipeline of compute core 202. In the example in FIG. 3, IOU 302 includes a directory 311, a DMA engine 312, and an MMU 313. In some examples, MMU 313 includes a translation lookaside buffer (TLB) configured to cache address translation information. Directory 311 can store or access mapping information used to determine where a tensor (or a portion of a tensor) is located in the interconnect structure, such as identifying a source APR that currently holds the tensor data or identifying an addressable location associated with the tensor. MMU 313 can perform address translation or other address-space related processing. In some examples, compute core 202 further includes an LMEM coupled with MMU 313, and MMU 313 can access LMEM when temporary local storage is used for an application or for intermediate results. LMEM is not shown in FIG. 3. Directory 311 and MMU 313 are described in further detail with respect to FIG. 5. DMA 312 can generate and manage transfer requests through router 250 to move data from a source location (e.g., a source APR) toward compute core 202 and into storage that is usable by the execution pipeline, such as directly into register files 305.

As used herein, register files 305 are in-core storage used to hold operand data for instruction execution by execution logic 308. In contrast, memory (not shown) can include (i) a shared memory structure accessible by multiple compute cores for storing and exchanging data, and/or (ii) an LMEM used for local buffering or temporary storage. In the examples described with respect to FIGS. 1-3, inter-core data exchange is not performed by writing data into shared memory. In addition, inter-core data exchange is not performed by first receiving the data into LMEM and then moving the data from LMEM into register files (e.g., register files 305) for execution. For example, in compute core 202, tensor data received through router 250 and IOU 302 can be provided as operand data directly into register files 305 (e.g., from a destination APR such as APR 212), without requiring the tensor data to be staged in shared memory or in LMEM prior to being used as operand data by execution logic 308.

Several components shown in FIG. 3 can vary across implementations, and FIG. 3 illustrates one example arrangement. Instruction fetch and decode logic 303 can obtain instructions associated with a capsule code (or an instruction stream derived from capsule codes) and decode those instructions into internal operations that will be scheduled for execution. Scoreboard 304 can track whether operand data needed by decoded operations is available and can track dependencies among operations, including dependencies on incoming tensor data that is still in transfer. Register files 305 can store operands and intermediate values used by execution logic 308. Reservation station 306 can hold decoded operations while waiting for operands to become available and while waiting for execution resources. Scheduler 307 can select ready operations for issuance to execution logic 308. Execution logic 308 (e.g., an arithmetic/logic datapath, which can be referred to as an ALU or a set of execution units) can perform the computations specified by the issued operations and can produce results for write-back, for local reuse, and/or for outbound staging through IOU 302. Accordingly, the functions described for blocks 303-308 are provided as examples, and different implementations can organize these functions in different ways while still coordinating operand availability with inbound and outbound transfers through IOU 302.

A detailed example is described below to illustrate how compute core 202 can determine where to obtain tensor data and how transfers can be coordinated with instruction execution. In one example, capsule code 301₀ can include one or more identifiers for input tensors needed by an operation and can include or reference one or more instructions that consume those input tensors. When capsule code 301₀ is received, IOU 302 can parse or otherwise obtain the tensor identifiers from capsule code 301₀. IOU 302 can consult directory 311 to determine a source location for at least one needed input tensor. For example, directory 311 can indicate that an identified tensor (or a portion of that tensor) is currently stored in a source APR (e.g., APR 214) associated with router 250. Using that mapping information, DMA 312 can issue a prefetch request through router 250 to fetch the identified tensor data from the source APR and to deliver the tensor data toward compute core 202. In some examples, DMA 312 can request the data in one portion; in other examples, DMA 312 can issue the prefetch request for a tensor in multiple portions, such as multiple sub-tensors. DMA 312 can cause transaction packets to be sent through router 250, where transaction packets can include control flits and data flits for transferring the requested sub-tensors.

As the requested data arrives at IOU 302 from router 250, IOU 302 can provide the arriving operand data directly to register files 305, for example by writing the operand values into one or more register locations assigned to the operation. In some examples, the operand data is written into the register files 305 without first being staged in LMEM. In parallel, instruction fetch and decode logic 303 can decode the instructions associated with capsule code 3010 and place decoded operations into reservation station 306. Scoreboard 304 can mark the decoded operations as not ready until the required operand data have been written into register files 305. When IOU 302 writes the operand data into register files 305, scoreboard 304 can update operand availability state, and reservation station 306 and scheduler 307 can treat the corresponding operations as ready for issue. Scheduler 307 can then issue ready operations to execution logic 308. Execution logic 308 performs the computation using operand data read from register files 305 and produces results. The results can be written back into register files 305 for subsequent operations within compute core 202. Again, no access to memory is needed. In addition, if at least a portion of the result is to be consumed by another compute core, IOU 302 can receive the result (e.g., from a write-back path not shown in FIG. 3 or from register files 305) and DMA 312 can initiate an outbound transfer through router 250 to place the results into an APR (e.g., an output APR) directly coupled with compute core so that another compute core can retrieve the results. In this example, compute core 202 acts as a destination core for receiving input tensor data and can act as a source core for staging output data, and the IOU 302 can provide the mechanism for both inbound prefetch and outbound staging.

FIG. 4 illustrates an example capsule code 400 that can be used to convey both tensor-related information and execution instructions for an operation. Capsule code 400 is shown as one possible format for representing what tensor data is to be obtained or transferred and what computation is to be performed. Each of capsule codes 301₀-301₃ in FIG. 3 can have a same or similar structure as capsule code 400. This format is provided as an example, and other formats can also be used.

In the illustrated example in FIG. 4, capsule code 400 is arranged as a sequence of fixed-width words, such as 36-bit words. Each word includes a prefix field that indicates the type of the word. Capsule code 400 includes an operator/control word (OP word 401), one or more input/output words (IO words 402), and one or more execution words (EXE words 403). In this example, the OP word appears first, followed by the IO words, and then by the EXE words, although other orderings can also be used.

OP word 401 can provide high-level information used to interpret the remainder of capsule code 400. For example, OP word 401 can identify an operator (e.g., operators 107-110 in FIG. 1) associated with the capsule code and can indicate how many input tensors (e.g., input tensors 101 and 102) and output tensors (e.g., output tensor 103) are referenced. As shown in FIG. 4, OP word 401 can include fields such as a prefix 405 indicating the word type, one or more reserved bits 406, a field 407 indicating a number of output tensors, a field 408 indicating a number of input tensors, and an operator identifier 409. Bracket notations such as “[3:0]” identifies how many bits are used for a particular field within a word. For example, “[3:0]” indicates that the field occupies four bits of the word, and “[15:0]” indicates that the field occupies sixteen bits of the word. The numbers in the brackets refer to bit positions within the word and are used only to illustrate field width and placement.

Each IO word 402 (e.g., IO word 402₀-402₃) can correspond to one tensor referenced by capsule code 400, such as an input tensor or an output tensor. Capsule code 400 can include multiple IO words, for example, to identify multiple input tensors (e.g., input tensor IDs in IO word 402₀-402₂) and one or more output tensors (e.g., output tensor ID in IO word 402₃). As shown in FIG. 4, an IO word can include a prefix 410 indicating the word type, one or more reserved bits 411, an optional partition index 412, and a tensor identifier 413. Tensor identifier 413 can be used to identify a tensor, and the partition index can be used to identify a sub-tensor or a portion of a tensor when a tensor is partitioned. Partition index field 412 can be optional because, in some cases, a tensor is transferred as a single unit and no partition identifier is needed, while in other cases a tensor is partitioned into sub-tensors for transfer, and the partition index identifies which sub-tensor the IO word refers to.

Each EXE word 403 can carry instruction-related information to be executed by a compute core (e.g., any of compute cores 202, 204, 206 and 208). As shown in FIG. 4, an EXE word can include a prefix 414 and an instruction 420 that encodes an instruction or a portion of instruction information. Capsule code 400 can include multiple EXE words (e.g., EXE words 404₀-404₃) to represent a sequence of instructions (e.g., instruction 420) associated with the operation.

In operation, a destination compute core (e.g., any of compute cores 202, 204, 206 and 208) can use the information in the IO words 402 to determine what tensor data should be prefetched or transferred before or during execution, and can use the instruction information (e.g., instruction 420) in the EXE words 403 to perform computation. Execution of the instructions 420 can be coordinated with the availability of operand data that is delivered based on the tensor identifiers (e.g., tensor identifier 413) carried in capsule code 400.

FIG. 5 illustrates an example directory 500 (e.g., directory 311) and an example MMU (e.g., MMU 313) page table 505 that can be used by a compute core (e.g., by IOU 302 of compute core 202) to associate a tensor identifier (e.g., tensor identifier 413) with location and address information. In some examples, directory 500 and MMU page table 505 are generated during compilation and stored at each compute core. The illustrated structures are examples, and other mapping structures can also be used.

Directory 500 can include entries that associate a tensor identifier with location and address information. In the illustrated example, directory 500 includes a node field 501, a partition_index field 502, a tensor ID field 503, and an address field 504. Tensor ID field 503 can store a tensor ID (e.g., tensor identifier 413 in FIG. 4). Partition_index field 502 can be optional, consistent with the optional partition index 412 in FIG. 4, because some tensors are handled as a single unit and do not use partitioning, while other tensors are partitioned into sub-tensors and use partition_index values to distinguish the sub-tensors. Node field 501 can identify a node on the interconnect structure, such as an identifier for a compute core or another interconnect location associated with the tensor data. Address field 504 can represent an address (e.g., address 104, 105, or 106) assigned for the tensor data in an address space (e.g., memory space 100). In some examples, the address field 504 identifies one or more addresses of associated APR locations on the interconnect structure, such that the tensor identifier maps to addressable storage locations of the APRs.

MMU page table 505 can include entries that associate a tensor identifier with a physical address when local storage is used. In the illustrated example, MMU page table 505 includes a partition_index field 506, a tensor ID field 507, and a physical address field 508. Tensor ID field 507 can store the same kind of tensor ID as tensor ID field 503 in directory 500, and can correspond to the tensor ID carried in capsule code (e.g., capsule code 301 or 400). Partition_index field 506 can be optional and can correspond to partition_index field 502 in directory 500 and partition index 412 in FIG. 4 when a tensor is partitioned. Physical address field 508 can identify a location in LMEM (or another local physical storage location) when LMEM is used for temporary storage or intermediate results.

In some examples, directory 500 and MMU page table 505 are used together during a prefetch operation initiated by a destination compute core (e.g., compute core 202). For example, the destination compute core can obtain a tensor ID (e.g., tensor identifier 413) and, when present, a partition index (e.g., partition index 412) from capsule code (e.g., capsule code 301), and can use the tensor ID (and optional partition index) to locate a corresponding entry in directory 500. From the directory entry, the destination compute core can obtain a node value (at node field 501) indicating a source location for the tensor data and an address value (at address field 504) associated with the tensor data. When a physical address is used, for example when LMEM is used, the destination compute core can also use the same tensor ID (and optional partition index) to access a corresponding entry in MMU page table 505 and obtain the physical address (at physical address field 508). In this way, directory 500 can provide location information for obtaining tensor data across nodes, and MMU page table 505 can provide a physical address for LMEM-related access when LMEM is used.

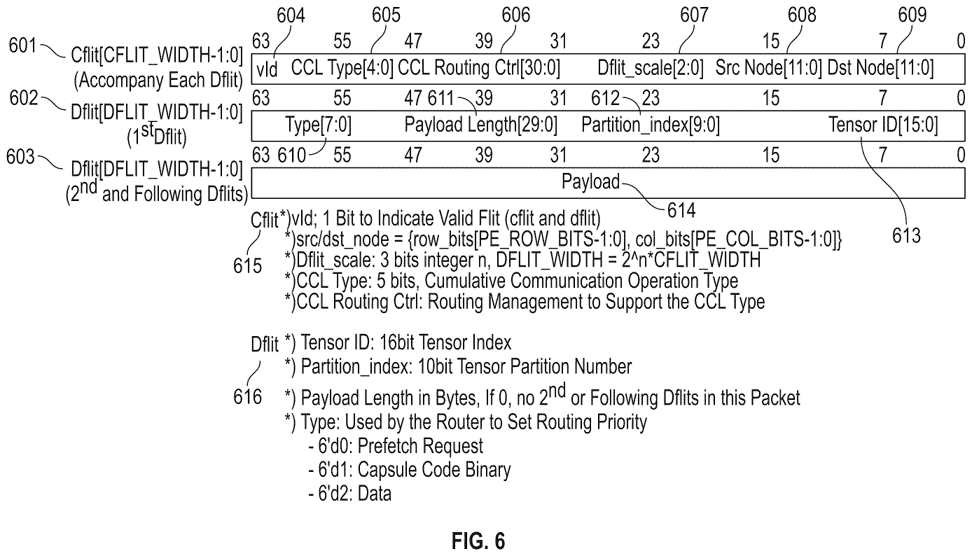

FIG. 6 illustrates an example flit-based transport format that can be used on an interconnect structure to carry control information and payload content associated with transfers such as prefetch traffic, capsule code traffic, and tensor data traffic. In the illustrated example, a transaction packet can include a control flit 601 (Cflit) and one or more data flits (Dflit), for example, data flit 602 and data flits 603. Control flit 601 can provide routing and transfer-context information for routers and endpoints, while data flits 602-603 can carry payload content and, in some examples, payload-associated identifiers. The illustrated field layouts are examples, and other layouts can also be used.

Control flit 601 is shown as a control unit that can accompany a transaction packet. Control flit 601 can include a valid field 604 (“vld”), a transaction/type field 605 (“CCL Type”), routing control information 606 (“CCL Routing Ctrl”), a scaling/configuration field 607 (“Dflit_scale”), a source-node identifier field 608 (“Src Node”), and a destination-node identifier field 609 (“Dst Node”). In use, valid field 604 can indicate whether control flit 601 is to be treated as valid, type field 605 can indicate a transaction category associated with the transaction packet, routing control field 606 can carry routing-related control information used by routers, scaling field 607 can indicate a relationship between control and data flit formatting (e.g., a width or scaling relationship used by the interconnect structure), and src/dst node fields 608-609 can identify the source node and destination node for the packet as it traverses the interconnect structure.

Data flit 602 is shown as a “1st Dflit,” and data flits 603 are shown as “2nd and following Dflits.” In the illustrated example, data flit 602 can carries several header-like fields in addition to payload (payload not shown in FIG. 6), while the second and following data flits 603 can be used to carry additional payload bytes (e.g., payload 614). Data flits 602 and 603 can include a type field 610 (“Type”), a payload length field 611 (“Payload Length”), a partition_index field 612 (“Partition_index”), a tensor ID field 613 (“Tensor ID”), and a payload field 614 (“Payload”). Type field 610 can indicate a category of the data flit traffic; the example Dflit layout 616 shows example categories that include a prefetch request, capsule code binary, and data. Payload length field 611 can indicate a payload size, and tensor ID (e.g., tensor identifier 413) field 613 can identify a tensor. Partition_index field 612 can be optional, consistent with the optional partition index 412 in FIG. 4, because some transfers may carry an unpartitioned tensor while other transfers may carry a particular sub-tensor, in which case partition_index distinguishes among sub-tensors. Payload field 614 carries the transferred bytes associated with the indicated traffic type, such as bytes of tensor data, bytes of capsule code, or other content.

FIG. 6 also includes example bitfield layouts 615 and 616 that correspond to the Cflit and Dflit formats. Example Cflit layout 615 shows one example arrangement of the Cflit fields within a fixed-width control flit, including fields corresponding to valid 604, CCL Type 605, CCL Routing Ctrl 606, Dflit_scale 607, src Node 608, and dst Node 609. Example Dflit layout 616 shows one example arrangement of the Dflit fields, including fields corresponding to Type 610, Payload Length 611, Partition_index 612, Tensor ID 613, and Payload 614, and also reflects that a first Dflit (such as Dflit 602) can include the identifier and length fields together with an initial payload portion, while second and following Dflits (such as Dflits 603) can carry additional payload portions for the same packet.

In operation, FIG. 6 illustrates one way that an interconnect structure can carry both “what to do” and “the data to do it with.” For example, a destination compute core (e.g., compute core 202) can issue a prefetch request that is carried using one or more flits; the Cflit can provide routing and context (e.g., using fields 605-609), while the Dflits can carry identifiers such as tensor ID 613 and, when used, partition_index 612, along with payload bytes 614. Similarly, capsule code content can be carried as payload (e.g., indicated by Type 610), and tensor data itself can be carried as payload across one or more Dflits.

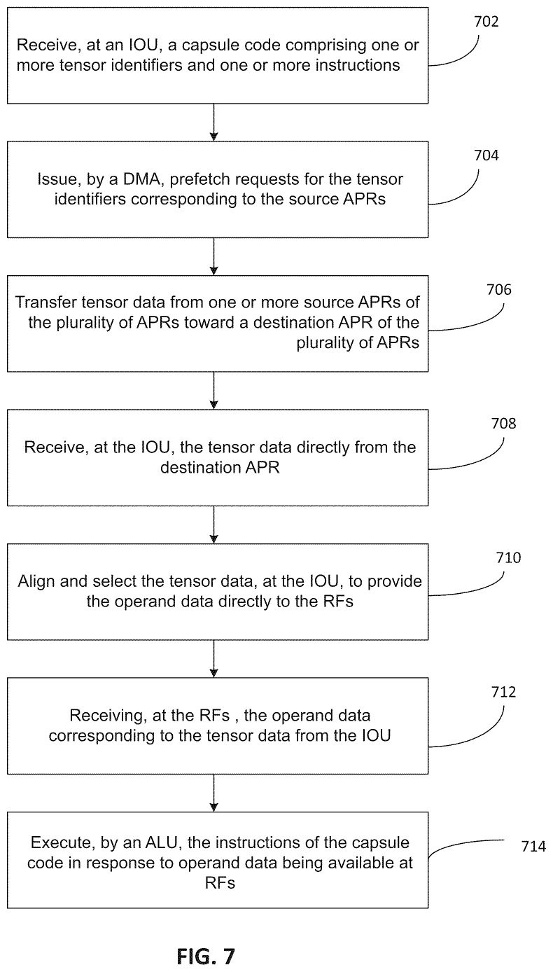

FIG. 7 illustrates a flowchart of an example method for dataflow management performed by a computing system having a plurality of compute cores(e.g., compute cores 202-208) coupled by an interconnect structure (e.g., router 250) that includes multiple APRs (e.g., APRs 212-230). The method illustrates one way to coordinate tensor-level data transfer with instruction execution using capsule code, so that a destination compute core (e.g., compute core 202) can obtain operand data through APR-based transfers and execute instructions (e.g., instruction 420) when the operand data becomes available at register files (e.g., register files 305). The blocks shown in FIG. 7 are examples, and in other examples one or more steps can be combined, reordered, or performed with additional or fewer sub-operations.

At block 702, an IOU (e.g., IOU 302) of the destination compute core receives a capsule code comprising one or more tensor identifiers and one or more instructions. For example, the capsule code can be a capsule code 400 as described with respect to FIG. 4, where an IO word 402 can carry a tensor identifier 413 and, when used, a partition index 412, and an EXE word 403 can carry instruction information. The capsule code received at block 702 can therefore identify which tensor data is to be obtained and can also provide instruction information to be executed by the destination compute core.

At block 704, a DMA engine (e.g., DMA 312) of the destination compute core issues prefetch requests for the tensor identifiers corresponding to one or more source APRs. In some examples, the prefetch requests are generated using mapping information such as a directory (e.g., directory 500) and an MMU page table (e.g., MMU page table 505), where a tensor identifier (and optional partition index) can be mapped to a node value (e.g., node 501) and address information (e.g., address 504) to support locating tensor data and initiating transfer. In some examples, the prefetch request can be carried over the interconnect structure using flits as described with respect to FIG. 6. In some examples, each transaction packet includes control information and addressing information determined from the directory (e.g., node and address values obtained from directory 500) for routing the packet through the interconnect structure.

In some examples, a transaction layer protocol is used to coordinate prefetch and transfer behavior across the interconnect structure. For example, the transaction layer protocol can coordinate issuing of the prefetch requests by the DMA (as in block 704) and can coordinate transferring of the tensor data along the plurality of APRs (as in block 706). In some examples, the transaction layer protocol can use control information and addressing information derived from the directory to form or interpret transaction packets carried on the interconnect structure, such as transaction packets that include control flits and data flits as described with respect to FIG. 6. In this way, the transaction layer protocol can provide a consistent mechanism for associating a prefetch request with subsequent tensor-data transfer and for coordinating the movement of tensor data through one or more intermediate APRs toward a destination APR.

At block 706, tensor data is transferred from one or more source APRs toward a destination APR that is coupled with the destination compute core. In this block, the tensor data can traverse the interconnect structure and can be staged through one or more intermediate APRs along a path, as described with respect to FIG. 2. This block illustrates that tensor data transfer can occur through APR-based staging along the interconnect structure rather than by writing the tensor data to and later reading the tensor data from a typical memory structure as an intermediate transfer medium.

At block 708, the IOU of the destination compute core receives the tensor data directly from the destination APR. For example, IOU 302 of compute core 202 can receive the tensor data directly from APR 212. In some examples, receiving the tensor data includes receiving one or more transaction packets carried as control flits and data flits (e.g., using a Cflit and one or more Dflits as described with respect to FIG. 6) and associating the received payload with a tensor context using a tensor identifier (e.g., tensor identifier 413) and, when used, a partition index (e.g., partition index 412). In some examples, this block places the received tensor data at a location accessible to the IOU for operand preparation.

At block 710, the IOU aligns and selects the received tensor data to generate operand data and provide operand data directly to one or more register files (RFs) of the destination compute core. In some examples, alignment and selection include selecting particular elements, partitions, or slices of the received tensor data and arranging the selected data into operand-width units expected by the execution pipeline. This block can be performed by the IOU so that operand data is provided to the RFs without using memory as an intermediate transfer medium. In this way, the destination APR can provide the tensor data to RFs directly coupled to the destination compute core through the IOU.

At block 712, the RFs receive the operand data corresponding to the tensor data from the IOU. In some examples, the RFs provide higher data transfer bandwidth for computation than memory, and the operand data placed in the RFs can be made available for instruction execution. This block corresponds to the destination compute core preparing operand availability for the instruction stream associated with the capsule code.

At block 714, an ALU of the destination compute core (e.g., EXE 308) executes the instructions of the capsule code in response to operand data being available at the RFs. In some examples, the destination compute core includes dependency tracking and scheduling logic (e.g., as described with respect to FIG. 3) that delays issuance of an instruction until the operand data required by that instruction is available in the RFs. In some examples, the transaction layer protocol synchronizes tensor-level prefetch with operand-level instruction execution such that execution of the instructions is triggered in response to the operand data being available at the RFs. Execution can produce result data that is stored locally for subsequent instructions and/or staged into an output APR for retrieval by another compute core, consistent with the interconnect and APR-based transfer examples described with respect to FIG. 2 and FIG. 3.

The foregoing specification is to be understood as being in every respect illustrative and exemplary, but not restrictive, and the scope of the invention disclosed herein is not to be determined from the specification, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

What is claimed is:

1. An integrated circuit system for dataflow management, the system comprising:
a plurality of compute cores, wherein each of the compute cores includes:
one or more register files configured to store operand data;
an algorithm-logic unit (ALU) coupled to the one or more register files and configured to perform operations based on the operand data in the one or more register files; and
an input/output unit (IOU) coupled to the one or more register files and the ALU; and
an interconnect structure configured to couple the plurality of compute cores through the IOU of the respective compute core, the interconnect structure comprising a plurality of addressable pipeline registers disposed between different compute cores of the plurality of compute cores, wherein:
at least one of the plurality of addressable pipeline registers is coupled directly to the one or more register files in a compute core of the plurality of compute cores through the input/output unit of the respective compute core.

2. The system of claim 1, wherein at least one of the plurality of addressable pipeline registers is configured to store computation results received from one or more coupled compute core of the plurality of compute cores.

3. The system of claim 1, wherein at least one of the plurality of addressable pipeline registers is configured to provide data to the one or more directly coupled register files through the IOU of the respective compute core.

4. The system of claim 3, wherein the respective IOU is configured to generate operand data based on the data received from the at least one of the plurality of addressable pipeline registers and provide the operand data to the respective register files in the same compute core.

5. The system of claim 1, wherein the IOU of each of the compute cores comprises a directory, a direct memory access (DMA), and a memory management unit (MMU).

6. The system of claim 5, wherein the directory is configured to map a tensor identifier to one or more addresses of the associated addressable pipeline registers.

7. The system of claim 5, wherein the DMA is configured to access the respective addressable pipeline registers according to the directory.

8. The system of claim 5, wherein at least one of the compute cores further includes a local memory, the local memory being coupled with the MMU comprised by the same compute core.

9. The system of claim 1, wherein the plurality of pipeline registers is coupled with each other such that data flits are transferred directly between adjacent pipeline registers.

10. The system of claim 1, wherein the interconnect structure and the plurality of compute core is included in a semiconductor chip.

11. A method for dataflow management, the method being performed by a computing system having a plurality of compute cores and an interconnect structure having a plurality of addressable pipeline registers (APRs), the method comprising:
receiving, at an input/output unit (IOU) included in a destination compute core of the plurality of compute cores, a capsule code comprising one or more tensor identifiers and one or more instructions;
transferring tensor data from one or more source APRs of the plurality of APRs toward a destination APR of the plurality of APRs, the destination APR being coupled with the destination compute core;
receiving, at the IOU of the destination compute core, the tensor data directly from the destination APR;
executing, by an algorithm-logic unit (ALU) of the destination compute core, the one or more instructions of the capsule code in response to operand data being available at one or more register files (RFs) included in the destination compute core, wherein the one or more RFs have a higher data transfer bandwidth than memory.

12. The method of claim 11, wherein transferring the tensor data comprises:
transferring the tensor data in one or more transaction packets comprising a plurality of control flits and a plurality of data flits, each of the transaction packets comprising control information and addressing information determined from the directory.

13. The method of claim 11, further comprising:
prior to transferring tensor data, issuing, by a direct memory access (DMA) comprised by the IOU, one or more prefetch requests for the one or more tensor identifiers corresponding to the one or more source APRs of the plurality of APRs.

14. The method of claim 13, wherein issuing the one or more prefetch requests comprises:
issuing the one or more prefetch requests based on a directory within the IOU, the directory being configured to map the one or more tensor identifier to one or more addresses of the associated APRs.

15. The method of claim 11, further comprising:
prior to executing the one or more instructions, receiving, at the one or more RFs included in the destination compute core, the operand data corresponding to the tensor data from the IOU included in the destination compute core.

16. The method of claim 15, further comprising, in response to receiving the tensor data at the IOU of the destination compute core, and prior to receiving the operand data at the one or more RFs of the destination compute core,
aligning and selecting the tensor data, at the IOU of the destination compute core, to provide the operand data directly to the one or more register files of the destination compute core.

17. The method of claim 11, further comprising:
outputting one or more results of the execution to an output APR of the plurality of APRs.

18. The method of claim 17, wherein the output APR is the same APR as the destination APR.

19. The method of claim 11, wherein the tensor data is partitioned into a plurality of sub-tensor data identified by a partition index.

20. The method of claim 11, further comprising:
compiling, by a compiler, an application workload into the capsule code; and
producing, by the compiler, a compute application binary interface (ABI) for execution of one or more operations of the tensor data and a network-on-chip (NoC) ABI for routing on the interconnect structure according to the directory.

21. The method of claim 13, further comprising:
coordinating, by a transaction layer protocol, issuing of the one or more prefetch requests; and
coordinating, by the transaction layer protocol, transferring of the tensor data along the plurality of APRs.

22. The method of claim 21, further comprising:
synchronizing, by the transaction layer protocol, tensor-level prefetch with operand-level instruction execution such that executing of the one or more instructions of the capsule code is triggered in response to the operand data being available at the one or more RFs.
